(19) United States
(12) Patent Application Publication
(10) Pub. No.: US 2005/0141613 A1
(43) Pub. Date: Jun. 30, 2005

(54) Editing of encoded a/v sequences

(75) Inventors: Declan Patrick Kelly, Eindhoven (NL); Jozef Pieter Van Gassel, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., BA Eindhoven (NL)

(21) Appl. No.: 10/507,994

(22) PCT Filed: Feb. 17, 2003
(86) PCT No.: PCT/IB03/00659

(30) Foreign Application Priority Data
Mar. 21, 2002 (EP) 02076108.6

(51) Int. Cl. H04N 7/12

(52) U.S. Cl. 375/240.16; 375/240.15; 375/240.12

(57) ABSTRACT

A data processing apparatus (800) has an input (810) for receiving a first and second sequence of frame-based A/V data. A processor (830) edits the two sequences forming a third combined sequence. So-called “I-frames” are intra-coded, without reference to any other frame of the sequence. “P-frames” are coded with reference to one prior reference frame, and “B-frames” are coded with reference to one prior and one subsequent reference frame. The referential coding of a frame is based on motion vectors in the frame indicating similar macro blocks in the frame referred to. The processor identifies frames in the first sequence up to and including a first edit point and frames in the second sequence starting at a second edit point that have lost a reference frame. The processor (830) re-encodes each identified B-frames into a corresponding re-encoded frame by deriving motion vectors of the re-encoded frame solely from motion vectors of the original B-frame.

### FIELD OF THE INVENTION

The invention relates to a method and apparatus for editing of frame-based coded audio/video (A/V) data, in particular for but not limited to, audio/video data encoded according to the MPEG-2 standard. At least two sequences of frame-based A/V data are combined to form a third combined sequence based on frames of a first frame sequence up to and including a first edit point in the first sequence and on frames in a second sequence from and including a second edit point in the second sequence. Each of the first and second sequences is coded such that a number of frames (hereinafter “I-frames”) are intra-coded, without reference to any other frame of the sequence, a number of frames (hereinafter “P-frames”) are respectively coded with reference to one prior reference frame of the sequence, and the remainder (hereinafter “B-frames”) are respectively coded with reference to one prior and one subsequent reference frame of the sequence, the reference frame being an I-frame or a P-frame and the referential coding of a frame being based on motion vectors in the frame indicating similar macro blocks in the frame referred to.

### BACKGROUND OF THE INVENTION

MPEG is a video signal compression standard, established by the Moving Picture Experts Group (“MPEG”) of the International Standardization Organization (ISO). MPEG is a multistage algorithm that integrates a number of well known data compression techniques into a single system. These include motion-compensated predictive coding, discrete cosine transform (“DCT”), adaptive quantization, and variable length coding (“VLC”). The main objective of MPEG is to remove redundancy which normally exists in the spatial domain (within a frame of video) as well as in the temporal domain (frame-to-frame), while allowing inter-frame compression and interleaved audio. MPEG-1 is defined in ISO/IEC 11172 and MPEG-2 is defined in ISO/IEC 13818.

There are two basic forms of video signals: an interlaced scan signal and a non-interlaced scan signal. An interlaced scan signal is a technique employed in television systems in which every television frame consists of two fields referred to as an odd-field and an even-field. Each field scans the entire picture from side to side and top to bottom. However, the horizontal scan lines of one (e.g., odd) field are positioned half way between the horizontal scan lines of the other (e.g., even) field. Interlaced scan signals are typically used in broadcast television (“TV”) and high definition television (“HDTV”). Non-interlaced scan signals are typically used in computer. The MPEG-1 protocol is intended for use in compressing/decompressing non-interlaced video signals, and the MPEG-2 protocol is intended for use in compressing/decompressing interlaced TV and HDTV signals as well as for non-interlaced signals, such as movies on DVD.

Before a conventional video signal may be compressed in accordance with either MPEG protocol it must first be digitized. The digitization process produces digital video data which specifies the intensity and color of the video image at specific locations in the video image that are referred to as pels (pixel elements). Each pel is associated with a coordinate positioned among an array of coordinates arranged in vertical columns and horizontal rows. Each pel's coordinate is defined by an intersection of a vertical column with a horizontal row. In converting each frame of video into a frame of digital video data, scan lines of the two interlaced fields making up a frame of un-digitized video are interdigitated in a single matrix of digital data. Interdigitization of the digital video data causes pels of a scan line from an odd-field to have odd row coordinates in the frame of digital video data. Similarly, interdigitization of the digital video data causes pels of a scan line from an even-field to have even row coordinates in the frame of digital video data.

Referring to FIG. 1, MPEG-1 and MPEG-2 each divides a video input signal, generally a successive occurrence of frames, into sequences or groups of frames (“GOF”) 10, also referred to as a group of pictures (“GOP”). The frames in respective GOFs 10 are encoded into a specific format. Respective frames of encoded data are divided into slices 12 representing, for example, sixteen image lines 14. Each slice 12 is divided into macroblocks 16 each of which represents, for example, a 16×16 matrix of pels. Each macroblock 16 is divided into a number of blocks (for example 6 blocks) including some blocks 18 relating to luminance data and some blocks 20 relating to chrominance data. The MPEG-2 protocol encodes luminance and chrominance data separately and then combines the encoded video data into a compressed video stream. The luminance blocks relate to respective 8×8 matrices of pels 21. Each chrominance block includes an 8×8 matrix of data relating to the entire 16×16 matrix of pels, represented by the macroblock 16. After the video data is encoded it is then compressed, buffered, modulated and finally transmitted to a decoder in accordance with the MPEG protocol. The MPEG protocol typically includes a plurality of layers each with respective header information. Nominally each header includes a start code, data related to the respective layer and provisions for adding header information. The example of 6 blocks from each macro block is one possibility (called the 4:2:0 format). MPEG-2 gives also other possibilities, such as having 12 blocks per macro block.

There are generally three different encoding formats which may be applied to video data. Intra-coding produces an “I” block, designating a block of data where the encoding relies solely on information within a video frame where the macro block 16 of data is located. Inter-coding may produce either a “P” block or a “B” block. A “P” block designates a block of data where the encoding relies on a prediction based upon blocks of information found in a prior video frame (either an I-frame or a P-frame, hereinafter together referred to as “reference frame”). A “B” block is a block of data where the encoding relies on a prediction based upon blocks of data from at most two surrounding video frames, i.e., a prior reference frame and/or a subsequent reference frame of video data. In principle, in between two reference frames (I-frame or P-frame) several frames can be coded as B-frames. However, since the temporal differences with the reference frames tend to increase if there are many frames in between (and consequently the coding size of a B-frame increases), in practice MPEG coding is used in such a way that in between reference frames only two B frames are used, each depending on the same two surrounding reference frames, as illustrated in FIG. 1 under number 10. To eliminate frame-to-frame redundancy, the displacement of moving objects in the video images is estimated for the P-frames and B-frames, and encoded into motion vectors representing such motion from frame to frame. An I-frame is a frame wherein all blocks are inter-coded. A P-frame is a frame wherein the blocks are inter-coded as P-blocks. A B-frame is a frame wherein the blocks are inter-coded as B-blocks. If no effective coding inter-coding is possible for all blocks of a frame, some blocks may be inter-coded as a P-block or even as an I-block. Similarly, some blocks of a P-frame may be coded as I-blocks. The dependencies between the different frame types is also illustrated in FIG. 2. FIG. 2A shows that the P-frame 220 depends on one preceding reference frame 210 (either a P-frame or an I-frame). FIG. 2B shows that a B-frame 250 depends on one preceding reference frame 230 and one subsequent reference frame 240.

With the increased availability of digitally encoded A/V and of data processing equipment capable of operating on such data, the need has arisen for seamless joining of A/V segments in which the transition between the end of one sequence of frames and the start of the next sequence of frames may be handled smoothly by the decoder. Applications for seamless joining of A/V sequences are numerous, with particular domestic uses including the editing of home movies and the removal of commercial breaks and other discontinuities in recorded broadcast material. Further examples include video sequence backgrounds for sprites (computer generated images); an example use of this technique would be an animated character running in front of an MPEG coded video sequence.

The inter-frame coding, as for example described for MPEG, achieves an effective coding but causes problems when two or more A/V segments need to be joined in a seamless manner forming a combined segment. The problem particularly occurs where a P or B frame has been taken over into the combined sequence, but one of the frames on which it depends has not been taken over into the combined sequence. WO 00/00981 describes a data processing apparatus for and a method of frame accurate editing of encoded A/V sequences wherein frames in a segment bridging the first and second sequence of frames are created by fully recoding the original frames. The bridging segment includes all frames that have lost a reference frame. The described method and apparatus are particularly oriented at optically stored video sequences, and rely on using a dedicated hardware encoder. Using the technique on a conventional data processing device, such as a PC, using a mainly software-based encoder can take a considerable time and discourage the user from editing, for example, home videos.

### SUMMARY OF THE INVENTION

It is an object of the invention to provide an improved data processing apparatus for editing encoded A/V sequences and an improved method of editing encoded A/V sequences. In particular, it is an object to enable software-based video editing.

To meet the object of the invention, the data processing apparatus for editing includes an input for receiving the first and second frame sequence; means for identifying frames in the first sequence up to and including the first edit point which are coded with respect to a reference frame after the first edit point and for identifying frames in the second sequence starting at the second edit point which are coded with respect to a reference frame before the second edit point; and a re-encoder for re-encoding identified frames of the B-type (hereinafter “original B-frame”) by, for each identified B-frame, deriving the associated motion vectors of the re-encoded frame solely from motion vectors of the original B-frame.

The inventors have realized that, unlike for conventional coding of A/V data, for video editing the original encoded frames are available and the encoded data therein can, to a certain extent, be re-used. In particular, the motion vectors can be re-used, avoiding a full recalculation of the motion vectors which includes motion estimation, which comes at a high cost in terms of computational resources.

As described in the dependent claim 2, if two (or more) B frames of the first sequence have lost a subsequent reference frame, all but the last B-frame are re-encoded as a single-sided B-frame depending only on the still present prior reference frame. The motion vectors of the B-frame with reference to the prior reference frame can still be used. Motion vectors with reference to the subsequent reference frame can no longer be used. This will on average lead to an increase of size of the frame. If for a reasonable number of macro-blocks motion vectors were present with respect to the previous reference frame (indicating a reasonable match), the size will be similar to that of a P-frame, that is also coded with reference to only one preceding frame. If not many motion vectors were present for the preceding reference frame, many macro-block have to be intra-coded. The resulting size will then be more similar to that of an I-frame. On average, the size increase will be moderate. Since for the conventional MPEG encoding only a few frames need to be re-encoded the resulting increase in size (and bit-rate) will usually fall well within the tolerance, since due to the variable bit-rate encoding of MPEG2 there is usually sufficient room for a temporary increase of the bit-rate.

As described in the dependent claim 3, the last identified B-frame of the first sequence is re-encoded to a P-frame depending only on the preceding reference frame. Existing motion vectors with reference to a preceding I-frame or P-frame are re-used.

As described in the dependent claim 4, as an alternative or as described in the dependent claim 8, preferably, in addition to re-encoding the B-frame as a single-sided B-frame depending only on the preceding reference frame, the newly created P-frame is (also) used as a reference frame. The motion vectors with reference to the P-frame can be based on the motion vectors that were used with reference to the subsequent reference frame. These motion vectors can enable an effective coding of the B-frame. Particularly, if also a high proportion of the motion vectors with reference to the preceding reference frame can be used, the code size of the B-frame may get very close to that can be achieved by a full re-encoding.

As described in the dependent claim 5, the direction of the motion vector is kept the same, but the length is reduced to compensate for the new reference frame being temporally (in time) closer.

As described in the dependent claim 6, the length is adapted according to the proportion that the new reference frame is temporally closer. This is a good approximation for images where the objects move substantially with a constant speed and direction over the duration of the frame sequence.

As described in the dependent claim 7, a search is performed along the length of the original motion vector. This enables finding a good match were the speed of the object changes, but the direction remains substantially the same during the duration of the involved frame sequence.

As described in the dependent claim 9, among the frames of the second sequence that have been taken over, a new reference frame is located, being either a P-frame or an I-frame. In the case that the first reference frame that is located is a P-frame, this frame is re-encoded to an I-frame. This ensures that in the second part of the combined sequence a suitable reference frame is present, being either the original I-frame or the newly created I-frame.

As described in the dependent claim 9, other identified B-frames in the second sequence are now re-encoded as single sided B-frames with reference to the newly created I-frame or the original I-frame, which ever situation occurs. The existing motion vectors can be re-used in an unmodified form.

These and other aspects of the invention are apparent from and will be elucidated with reference to the embodiments described hereinafter.

### BRIEF DESCRIPTION OF THE DRAWINGS

In the drawings:

FIG. 1 shows the prior art MPEG2-encoding;

FIG. 2 illustrates the inter-frame coding of MPEG-2;

FIG. 3 shows a display and corresponding transmission sequence of frames;

FIG. 4 shows the re-encoding of the first sequence up to and including the out-point (first edit point);

FIG. 5 shows the re-encoding of the first sequence for a different out-point;

FIG. 6 shows the re-encoding of the second sequence from and including the in-point (second edit point);

FIG. 7 shows the re-encoding of the second sequence for a different in-point; and

FIG. 8 shows a block diagram of a data processing apparatus according to the invention;

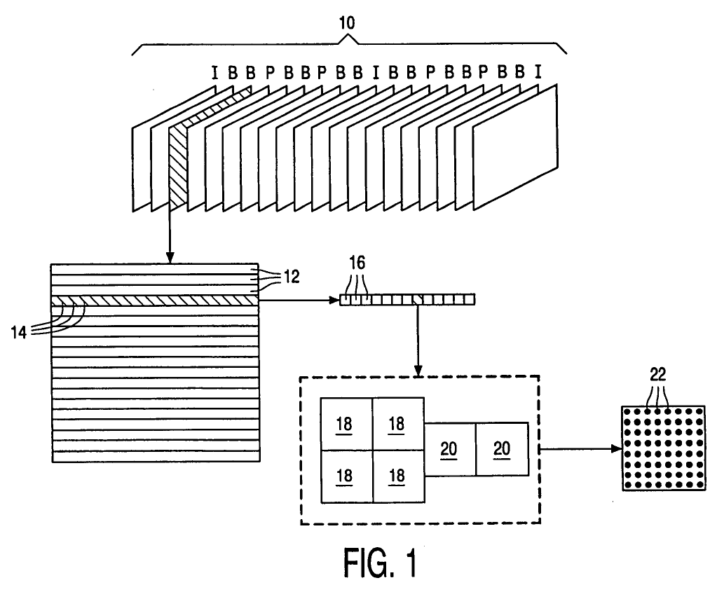

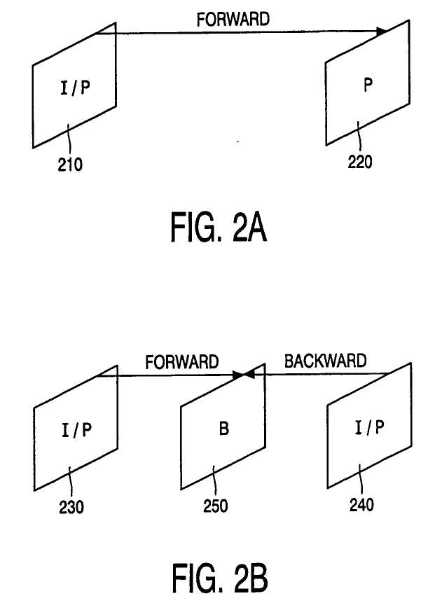

### DETAILED DESCRIPTION OF THE PREFERRED EMBODIMENT

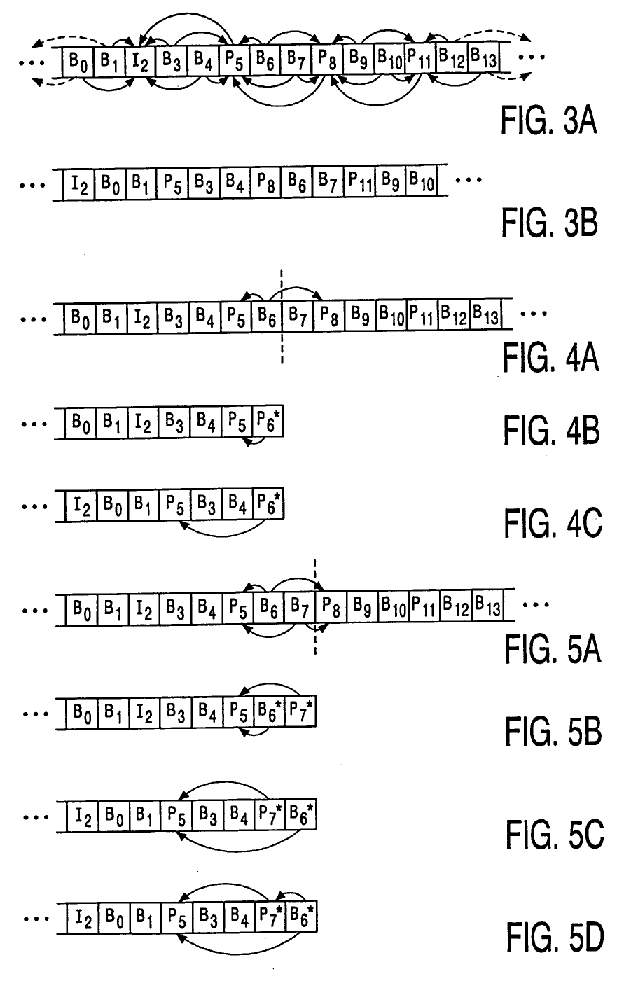

FIG. 3A shows an exemplary sequence of frames according to the MPEG-2 coding. Although the following description will focus on this coding, persons skilled in the art will recognize the applicability of the present invention to other A/V coding standards. FIG. 3A also shows the dependencies between the frames. Caused by the forward dependencies of the B-frames, transmitting the frames in the sequence as shown in FIG. 3A would have the effect that a received B-frame can only be decoded after the subsequent reference frame has been received (and decoded). To avoid having to ‘jump’ through the sequence during the decoding, frames are usually not stored or transmitted in the display sequence of FIG. 3A but in a corresponding transmission sequence as shown in FIG. 3B. In the transmission sequence, reference frames are transmitted before the B-frames that depend on them. This implies that the frames can be decoded in the sequence in which they are received. It will be appreciated that display of a decoded forward reference frame is delayed until the B-frames that depend on it have been displayed.

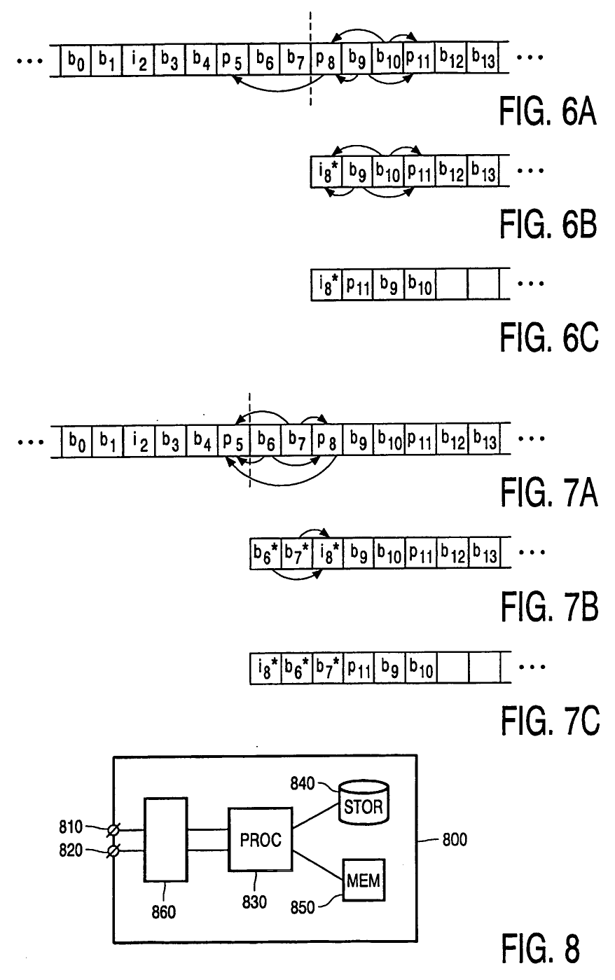

The data processing apparatus according to the invention combines frames of a first sequence up to and including a first edit point (out-point) with frames of a second sequence starting with the second edit point (in-point). As will be appreciated, frames of the second sequence (the in-sequence) may actually be taken from the same sequence as the frames of the first sequence. For example, the editing may actually involve removing one or more frames from a home video. Due to the dependency of frames over the edit points, re-encoding of some frames is required. According to the invention, the re-encoding re-uses existing motion vectors. No new motion estimation occurs during the re-encoding, resulting in a fast re-encoding. Consequently, frames taken over from the first sequence will, during the re-encoding, not be predicted with reference to frames of the second sequence, and vice versa. So, no coding dependency between the two segments will be established. The re-encoding is thus restricted to the segment itself. FIGS. 4 and 5 show re-encoding examples for the first sequence. FIGS. 6 and 7 show re-encoding examples for the second sequence. The combined sequence is simply a concatenation of the re-encoded segment of the first sequence with the re-encoded segment of the second sequence.

FIG. 4 illustrates re-encoding the first sequence where the out-point is frame B₆. This means that all frames up to and including B₆ are represented in the edited (combined) sequence, but that all frames that sequentially follow frame B₆ (in the display order) are not represented in the combined sequence. In the example, B₆ depends on P₅ and P₈. According to the invention, B₆ is re-encoded as a P-frame, indicated as P*₆. As shown P*₆ is coded with reference to P₅ only. The motion vectors of the original B₆ frame that were coded predicting from P₅ can be fully re-used in the P*₆ frame. No additional motion vectors need to be calculated. In particular, no motion estimation is required. Since P₈ will not be represented in the combined sequence, the motion vectors of B₆ for P₈ can no longer be used. As a consequence, on average more macroblocks in P*₆ will need to be coded as intra macroblocks then was the case for B₆. This will increase the size of B₆ (reduced coding efficiency), but no full re-encoding with the time consuming motion estimation is used. FIG. 4C shows the sequence of FIG. 4B but now in transmission sequence.

FIG. 5 illustrates re-encoding the first sequence where the out-point is frame B₇. In this example, both frames B₆ and B₇ are predicted with reference to P₅ as well as P₈. P₈ is not taken over. According to the invention, of the B-frames that have lost a reference frame, the last one is re-encoded to a P-frame. In this case, B₇ is re-encoded to frame P*₇, solely depending on P₅. The re-encoding is the same as described for B₆ of FIG. 4. All other B-frames that have lost a reference frame (in this case only B₆) are re-encoded as a single-sided B-frame coded with reference to the remaining reference frame (i.e. the preceding reference frame). As shown in FIG. 5B, B₆ is re-encoded to a single sided B*₆ frame predicted from P₅. The motion vectors of B₆ are re-used. The motion vectors of B₆ for P₈ can no longer be used. Consequently, more macroblocks in B*₆ may need to be coded as intra macroblocks then was the case for B₆.

FIG. 5D illustrates a preferred embodiment, wherein motion vectors are created for predicting the re-encoded frame B*₆ from the re-encoded frame P*₇. In itself no motion vectors were present in the original frame B₆ predicting from B₇. However, motion vectors of B₆ predicting from P₈ can be re-used for this purpose. Taking the example of FIG. 5A and the conventional A/V encoding wherein the frames are located in the sequence at a fixed time interval, the time between frames B₆ and P₈ is twice the time between frames B₆ and B₇. Assuming that the motion of objects is substantially constant during the time interval B₆ to P₈, halving the length of the motion vectors gives a reasonable estimation of motion vectors for predicting B*₆ from P*₇. Preferably, these motion vectors are used in addition to the motion vectors predicting B*₆ from P₅. In this latter case, this makes B*₆ a regular double-sided B-frame. The example of FIG. 5 describes the normal situation of MPEG-2 where two B-frames are located in between reference frames. The person skilled in the art can easily adapt this for situation where there are more than two B-frames in between reference frames. In such a more general case, the factor with which the length of the motion vector needs to be corrected is given by: (the number of frames in between the B*-frame and the P*-frame+1). /(the number of frames in between the original B-frame and its subsequent reference frame+1).

In a further preferred embodiment, the accuracy of the matching of the motion vectors predicting B*₆ from P*₇ is increased by varying the length of the original motion vectors predicting B₆ from P₈ with a factor between 0 and 1. Preferably, a binary search is performed in this interval starting at 0.5 (which is anyhow a good match for constant motion). Using the searching technique, a good match can be found for objects where the direction of motion remains substantially constant during the involved time interval.

FIG. 6 illustrates re-encoding the second sequence where the in-point is frame p₈. This means that all frames starting at p₈ are represented in the edited (combined) sequence, but that all frame that sequentially precede p₈ (in the display order) are not represented in the combined sequence. According to the invention, starting at the in-point the first reference frame is located, being either an I-frame or a P-frame. If this frame is an I-frame it is taken over unmodified in the combined sequence. If the frame is a P-frame, it is re-encoded to an I-frame, i.e. all macroblocks are re-encoded as intra blocks. In the example of FIG. 6, the first reference frame is p₈. So, p₈ is re-encoded to i*₈. Frames b₉ and b₁₀ are the B-frames that already depended on the reference frame p₈. The motion vectors can be taken over. Consequently, b₉ and b₁₀ do not need to be re-encoded. FIG. 6B shows the resulting re-encoded frames in display sequence. FIG. 6C shows the same sequence in transmission sequence.

FIG. 7 gives a second example of re-encoding the second sequence where the in-point is frame b₆. Starting at the in-point, the first reference frame is frame p₈. As also described for FIG. 6, p₈ is re-encoded to i*₈. Next, all B-frames of the second sequence are identified that have lost a reference frame, being either an I-frame or a P-frame preceding the in-point b₆. In the example, b₆ and b₇ are such B-frames. The identified B-frames are re-encoded as single-sided B-frames. The reference to the preceding reference frame is removed. The dependency of the remaining subsequent reference frame is kept. In the example, the remaining subsequent reference frame P₈ is re-encoded to frame i*₈. So, b₆ and b₇ are re-encoded as frames b*₆ and b*₇, respectively, depending on i*₈.

FIG. 8 shows a block diagram of data processing system according to the invention. The data processing system 800 may be implemented on a PC. The system 800 has an input 810 for receiving a first and second sequence of A/V frames. A processor 830 processes the A/V frames. Particularly if the frames are supplied in an analogue format, additional A/V hardware 860 may be used, for example in the form of an analogue video sampler. The A/V hardware 860 may be in the form of a PC video card. If the frames have not yet been coded in a suitable digital format like MPEG-2, the processor may first re-encode the frames in the desired format. The initial coding or re-encoding to the desired format usually applies to the entire sequence and does not require user interaction. As such the operation can take place in the background or unattended, unlike video editing that usually requires intense user interaction to accurately determine the in and out-points. This makes real-time performance during editing more important. The sequences are stored in a background memory 840, such as a hard disk, or a fast optical storage subsystem. Although FIG. 8 shows that the A/V streams flow through the processor 830, in reality suitable communication systems, such as PCI and IDE/SCSI may be used to direct the streams directly from the input 810 to the storage 840. For the editing, the processor needs information on which sequences to edit and the in and out-points. Preferably, the user supplies such information via a user interface, like a mouse, and keyboard, in an interactive way, where a display provides the user information on available streams and, if desired, frame accurate locations in the streams. As described before, the user may actually be editing only one stream, such as a home video, by removing or copying selected scenes. For the purpose of this description, this is regarded as processing the same A/V sequence twice, once as the in stream (second sequence) and once as the out stream (first sequence). In the system according to the invention, both sequences can be processed independently, where the combined (edited) sequence is formed from concatenating both segments. Normally, the combined sequence will also be stored in the background storage 840. It can be supplied externally via output 820. Where desired, a format conversion may be done, e.g. conversion to a suitable analogue format, using the A/V I/O hardware 860.

As described above, for the editing the processor 830 determines the segments of the first and second sequence that need to be taken over in the combined sequence (all frame in the first sequence up to and including the out-point and all frames in the second sequence starting with the in-point). Next, the B-frames are identified that have lost one of the reference frames. These frames are re-encoded by re-using existing motion vectors. As has been described above, no motion estimation is required according to the invention. As has been indicated, certain macroblocks may need to be re-encoded as intra macroblocks. Intra coding (as well as inter-coding) is well-known and persons skilled in the art will be able to perform those operations. The re-encoding may be done using a special hardware. However, it is preferred to use the processor 830 for this purpose under control of a suitable program. The program may also be stored in the background storage 840, and during operation, be loaded in a foreground memory 850, such as a RAM memory. The same main memory 850 may also be used for temporarily storing (part) of the sequence that is being re-encoded. As described above for a preferred embodiment, the system is also operative to re-estimate the length of a motion vector. It falls well within the knowledge of a person skilled in the art to perform the preferred binary search and checking for an optimal match of the macroblock. The involved estimation of the optimal length of the motion vector is preferably performed by the processor 830 under control of a suitable program. If desired, also additional hardware may be used.

It should be noted that the above-mentioned embodiments illustrate rather than limit the invention, and that those skilled in the art will be able to design many alternative embodiments without departing from the scope of the appended claims. In the claims, any reference signs placed between parenthesis shall not be construed as limiting the claim. The words “comprising” and “including” do not exclude the presence of other elements or steps than those listed in a claim. The invention can be implemented by means of hardware comprising several distinct elements, and by means of a suitably programmed computer. In the system claims enumerating several means, several of these means can be embodied by one and the same item of hardware. The computer program product may be stored/distributed on a suitable medium, such as optical storage, but may also be distributed in other forms, such as being distributed via the Internet or wireless telecommunication systems.

1. A data processing apparatus (800) for editing at least two sequences of frame-based A/V data forming a third combined sequence based on frames of a first frame sequence up to and including a first edit point in the first sequence and on frames in a second sequence from and including a second edit point in the second sequence, wherein each of the first and second sequences is coded such that a number of frames (hereinafter “I-frames”) are intra-coded, without reference to any other frame of the sequence, a number of frames (hereinafter “P-frames”) are respectively coded with reference to one prior reference frame of the sequence, and the remainder (hereinafter “B-frames”) are respectively coded with reference to one prior and one subsequent reference frame of the sequence, the reference frame being an I-frame or a P-frame and the referential coding of a frame being based on motion vectors in the frame indicating similar macro blocks in the frame referred to;
the apparatus including:
an input (810) for receiving the first and second frame sequence;
means (830) for identifying frames in the first sequence up to and including the first edit point which are coded with respect to a reference frame after the first edit point and for identifying frames in the second sequence starting at the second edit point which are coded with respect to a reference frame before the second edit point; and
a re-encoder (830) for re-encoding each identified frames of the B-type (hereinafter also “original B-frame”) into a corresponding re-encoded frame by, for each identified B-frame, deriving motion vectors of the corresponding re-encoded frame solely from motion vectors of the original B-frame.

2. A data processing apparatus as claimed in claim 1, wherein the re-encoder is arranged to re-encode an identified B-frame of the first sequence other than the sequentially last one of the identified B-frames as a single-sided B-frame with reference only to the one prior reference frame.

3. A data processing apparatus as claimed in claim 1, wherein the re-encoder is arranged to re-encode a sequentially last one of the identified B-frames of the first sequence as a P-frame (hereinafter “P*-frame”), with reference to a preceding frame that is either an I-frame or a P-frame and that sequentially is closest.

4. A data processing apparatus as claimed in claim 3, wherein the re-coder is arranged to re-code an identified B-frame of the first sequence other than the sequentially last one of the identified B-frames as a B-frame (hereinafter “B*-frame”), with reference to the P*-frame, where motion vectors of the B*-frame with respect to the P*-frame are derived from motion vectors of the corresponding original B-frame with respect to the reference frame that is not part of the combined sequence.

5. A data processing apparatus as claimed in claim 4, wherein a direction of the motion vectors of the B*-frame is the same as the respective corresponding motion vectors of the corresponding original B-frame and the length of the motion vectors of the B*-frame is proportional to a length of the respective corresponding motion vectors of the corresponding original B-frame

6. A data processing apparatus as claimed in claim 5, wherein the proportion is given by: (the number of frames in between the B*-frame and the P*-frame+1)/(the number of frames in between the original B-frame and its subsequent reference frame+1).

7. A data processing apparatus as claimed in claim 5, where the apparatus includes a proportion estimator for estimating the proportion by iteratively scaling a length of the respective corresponding motion vectors of the original B-frame with a factor between 0 and 1 until a match of the corresponding macro block is found that meets a predetermined criterion.

8. A data processing apparatus as claimed in claim 4, wherein the re-encoder is arranged to re-encode the identified B-frame of the first sequence other than the sequentially last one of the identified B-frames also with reference to the prior reference frame.

9. A data processing apparatus as claimed in claim 1, wherein the re-encoder is arranged to sequentially scan the second sequence for an I-frame or a P-frame starting at the second edit point; and, if a P-frame is detected first, re-encode the detected P-frame to an I-frame (hereinafter “I*-frame”).

10. A data processing apparatus as claimed in claim 9, wherein the re-encoder is arranged to re-encode each identified B-frames in the second sequence as a single-sided B-frame, where the single-sided B-frame depends on the I*-frame, if the P-frame was detected first, or on the I-frame, if the I-frame was detected first.

11. A method of editing at least two sequences of frame-based A/V data forming a third combined sequence based on frames of a first frame sequence up to and including a first edit point in the first sequence and on frames in a second sequence from and including a second edit point in the second sequence, wherein each of the first and second sequences is coded such that a number of frames (hereinafter “I-frames”) are intra-coded, without reference to any other frame of the sequence, a number of frames (hereinafter “P-frames”) are respectively coded with reference to one prior reference frame of the sequence, and the remainder (hereinafter “B-frames”) are respectively coded with reference to one prior and one subsequent reference frame of the sequence, the reference frame being an I-frame or a P-frame and the referential coding of a frame being based on motion vectors in the frame indicating similar macro blocks in the frame referred to;
the method including:
receiving the first and second frame sequence;
identifying frames in the first sequence up to and including the first edit point which are coded with respect to a reference frame after the first edit point and for identifying frames in the second sequence starting at the second edit point which are coded with respect to a reference frame before the second edit point; and
re-encoding each identified frames of the B-type (hereinafter also “original B-frame”) into a corresponding re-encoded frame by, for each identified B-frame, deriving motion vectors of the corresponding re-encoded frame solely from motion vectors of the original B-frame.

12. A computer program product for causing a processor to perform the steps of claim 11.
